(19) United States
(12) Patent Application Publication
(10) Pub. No.: US 2021/0009031 A1
(43) Pub. Date: Jan. 14, 2021

(54) Safety Brakelight System

(71) Applicants: Jess M. Azores, Falls Church, VA (US); Augusto M. Azores, Lake Charles, LA (US)

(72) Inventors: Jess M. Azores, Falls Church, VA (US); Augusto M. Azores, Lake Charles, LA (US)

(21) Appl. No.: 16/863,645

(22) Filed: Apr. 30, 2020

Related U.S. Application Data
(60) Provisional application No. 62/921,829, filed on Jul. 9, 2019.

(51) Int. Cl. B60Q 1/44; B60T 11/10

(52) U.S. Cl. CPC B60Q 1/444; B60T 11/103

(57) ABSTRACT

This disclosure provides a three-color coded brake lights system, analogous to those found in common traffic lights. In one embodiment, a green light may be at the center, yellow or amber lights on both sides of the green light, and red lights adjacent to the yellow or amber lights. The system may operate analogous to a traffic light to signal the tailing driver on the real-time status and or behavior of a lead car, and also significantly mitigate the severity of rear-end and other collisions with the application of a three color-coded system being followed by global motorists for safe driving.

### CROSS REFERENCE TO RELATED APPLICATIONS

This application claims priority under 35 USC § 119(e) to U.S. Provisional Application No. 62/921,829, filed on Jul. 9, 2019 which is herein incorporated by reference in its entirety.

### BACKGROUND OF THE DISCLOSURE

### Field of the Invention

This disclosure is generally directed to brake light systems for motor vehicles including automobiles, trucks, motorcycles, utility vehicles, any other street legal vehicles, as well as off road vehicles.

### Description of the Related Art

Rear-end collisions, which account for about 28% of car accidents, are frequently mostly due to the absence of warning lights to let a tailing driver know that a lead car is slowing down and possibly getting ready to stop. The singular presence of a red light on the rear end of a car which in fact means stop but is lighted when the motor vehicle is still moving can catch a trailing driver by surprise not leaving enough time to avoid a collision.

According to a report by the National Highway Traffic Safety Administration (NHTSA) 28% of crashes are rear-end collisions causing physical injuries which can at times be fatal and cause damage to property. A Virginia Tech Transportation Institute (VTTI) performed a study, commissioned by the National Highway Traffic Safety Administration, to conduct research and a series of tests about rear-end collisions. VTTI's study encompassed many aspects of rear-end collisions, and some of the important findings were:
The majority of rear-end collisions occur when the leading vehicle is stopped or moving at a very slow speed. About 81 percent of rear-end accidents occurred when the lead vehicle was completely stopped. In most collisions, the driver was following too closely to the car in front of it.
Most rear-end collisions occur during daytime hours on dry, straight and level roads.
In nearly half of rear-end collisions, the driver following the vehicle failed to react to the stopped/slowed vehicle due to being distracted or not paying attention.
If the driver following the vehicle was eating, daydreaming, using a cell phone or conversing with a passenger, it was more likely to cause a rear-end collision. The study found that driver distraction was responsible for about 90 percent of rear-end collisions.
Male drivers between the ages of 25 and 34 were 1.9 times more likely than other age groups to be involved in a rear-end collision.

Generally speaking, there is a mistaken belief that all it takes is a red light in the rear-end of a car to altogether indicate that a car is stopped, on the go, or slowing down. This situation in fact puts a trailing driver in a precarious situation in the absence of a better warning light system on the lead vehicle.

Accordingly, the lack of advance warning signals on the rear of a vehicle slowing down and prematurely displaying an incongruous red-light signal prior to an actual stop presents a significant shortcoming in the state of the art of vehicle brake light systems. Addressing this shortcoming would enable a driver to assess the driving conduct of others which is a crucial factor for the safety of all motorists in the prevention of rear-end collisions, bodily harm, property damage and in some cases, resulting in unnecessary fatalities.

Moreover, the manifestation of a clear visual warning display system would immensely enhance the safety of drivers in all weather conditions day or night and would be most beneficial to seniors, those with less than 20/20 vision, and those with partial disabilities.

Accordingly, there is a need to redefine the discordant, traditional, hazardous and misleading red-light application which incongruously indicates the same state for an automobile in both the stopped and the slowing down conditions.

### SUMMARY OF THE INVENTION

This disclosure is directed to a differentiated functional, unique, brake management system utilizing a sequenced operation of three (3) color coded traffic commands, to vividly indicate a car in the stop and go mode and when slowing down, illustrating a novel proactive safety solution to alleviate the ambiguity of rear-end red lights in a real time driving environment. The disclosure is generally directed to the functional migration of the three (3) color-coded command traffic light signals and incorporating it onto motor vehicles, with a plurality of lights and shapes, relative to the options and designs of motor vehicle manufacturers.

The disclosure relates to the analogous application of universal traffic light system found at intersections which controls traffic flow following the recognized and understood colors of red, green, yellow, or amber lights, to signal an appropriate indication to either stop, go, or caution in safe a brake light system.

This includes a safety light display system which includes the measurement of the pressure applied on a brake pedal by a sensor, sending data to a microprocessor which interprets the sensor signals, and transmitting the appropriate color-coded traffic signal to a safety light display system optionally positioned, for example, on a rear window windshield of a vehicle and/or a tail end of a vehicle's body.

The disclosure thus provides for appropriate lighting, optionally matching a vehicle's design to indicate the state of a vehicle in a stop, go, or in-between state, in real-time, and in conformity with international color-coded traffic signal light systems. That is, red for stop, yellow for caution, and green for go. This provides for a well-managed and controlled flow of traffic strictly enforced and respected worldwide for a much safer drive, over and beyond intersections, and alleviating road-hazards.

Other features and aspects will be apparent from the following detailed description, the drawings, and the claims.

### BRIEF DESCRIPTION OF THE DRAWINGS

FIG. 1 shows one embodiment of the present disclosure.

FIG. 2 shows another embodiment of the disclosure.

FIG. 3 shows a diagram of an embodiment of a brake light system of the disclosure.

FIG. 4 shows an embodiment of a brake light of the disclosure.

FIG. 5 shows an embodiment of brake lights of the disclosure.

FIG. 6A shows an embodiment of a car with brake lights of the disclosure.

FIG. 6B shows an exploded view of brake lights of FIG. 6A.

FIG. 7 shows a car with brake lights of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

This disclosure provides a three-color system of brake lights, analogous to those found in stop or traffic lights. In one embodiment, a green light is strategically positioned at a center, yellow or amber lights on both sides of the green light, and red lights adjacent to the yellow or amber lights. The system may operate analogous to a stop light or traffic signal to a tailing driver on the status and or behavior of a leading motor vehicle.

On the highway, at night and in inclement weather, a motorist will be able to see the real-time flow of traffic by the changing color of lights being displayed on the rear ends of motor vehicles in traffic and be able to spot where a bottle neck is and take necessary action. This represents a significant improvement over seeing redundant red lights and not being able to tell whether cars are moving slowly or are actually stopped. When brakes are tapped, the color displays yellow or amber, when brakes are more fully depressed displays red, and green may be the default display color.

This disclosure provides the effectiveness of traditional traffic color-coded traffic signals of green for go yellow for caution and red for stop. This thus provides an analogous system for use in motor vehicles, for example, in a rear upper or lower rear windshield or anywhere on a vehicle tail end as appropriate. The disclosure thus provides a display of color-coded signals being observed the world over to act as a precautionary measure for driver awareness of traffic conditions in their area of responsibility and are not placed in a situation with an accident waiting to happen, which effectively controls traffic flow on busy intersections globally which would be unimaginable and chaotic without the presence of the color-coded command signal lights.

With this practical invention display system in place, for example, drivers passing under a traffic light signal indicating a green color will likewise have green color in their rear display, within reasonable proximity to the traffic light, which may be the default color having no pressure on the brake pedal. Drivers partially stepping on the brake pedal in their approach to a red traffic light signal will display a yellow color on their rear display as advance caution in anticipation of a full stop at a red traffic light signal, thereby offering drivers a more accurate and positive comprehensive view of impending traffic and awareness that a stopped vehicle is ahead.

The lights may be positioned on the back of the vehicle such that drivers in vehicles driving behind can see the lights. There may be one or more green lights, one or more yellow lights, and one or more red lights. In embodiments, the one or more green light(s) may be positioned with one or more yellow lights adjacent to and on both sides of the green light(s), and one or more red lights are positioned adjacent to and on both sides of the one or more yellow lights. In embodiments, the one or more green lights, the one or more yellow lights, and the one or more red lights are positioned substantially in a horizontal plane. In embodiments, the one or more green lights, the one or more yellow lights, and the one or more red lights are positioned substantially in a vertical plane.

The above mentioned configurations are examples and the disclosure generally contemplates any configuration of the lights with respect to each other so long as they can be seen by a driver in a vehicle driving behind a subject vehicle.

The color green as used herein may refer to green light in the approximately 495-570 nm wavelength range. In addition, in a preferred embodiment, green color may refer to a color close to, or the same as, green light used internationally in traffic light signals.

The color red as used herein may refer to red light in the approximately 620-740 nm wavelength range. In addition, in a preferred embodiment, red color may refer to a color close to, or the same as, the red light used internationally in traffic light signals.

The color yellow can refer to yellow or amber light in the approximately 570-620 nm wavelength range. In addition, in a preferred embodiment, the yellow or amber color may refer to a color close to, or the same as, the yellow or amber light used internationally in traffic light signals. The definition of yellow light as used herein is generally understood to encompass both the color of yellow and amber lights used in traffic light systems.

Brake systems as used herein generally include hydraulic braking systems typically used in passenger vehicles and trucks. Brake systems as used in motorcycles and other vehicles that can be used on a public roadway are also contemplated. Hydraulic brakes generally comprise the following: when the brake pedal is depressed a piston in a main or master cylinder is moved and produces a pressure through a hydraulic fluid in the brake system. This pressure activates a braking mechanism against one or more wheels of the vehicle typically including brake shoes and a brake drum.

An illumination and intensity mechanism can be provided to vary the intensity of the brake lights, for example, for daytime and nighttime driving. Mechanisms can also be provided to intermittently flash the brake lights, such as during an emergency.

In one embodiment, the system is connected to a hydraulic braking system and configured to produce different signals and activate different brake lights in responsive to different hydraulic braking pressures exerted on the braking system by the brake pedal.

The invention senses and indicates whether the braking system is activated, and also senses and indicates the degree to which the braking system is activated, e.g., slight braking, moderate braking, greater braking, or maximum braking.

A pressure sensor or transducer as described herein may be any pressure sensor or transducer that can measure the amount of force being applied to a brake pedal and output a corresponding signal.

Generally speaking, a transducer is a device that receives energy from one system and retransmits it in another form to another system. For example, a transducer may receive energy from a hydraulic brake system and convert it into electrical energy that could be transmitted to a microprocessor. The transducer can be configured to measure the pressure within the hydraulic brake system and in turn, retransmit this pressure as electrical energy to a microprocessor.

The brake pressure transducer can be calibrated from 0% to 100% such that 100% maximum pressure completely stops the vehicle's wheels and 0% represents the condition of no pressure being applied to the brake pedal by a vehicle operator.

In one embodiment, when the brake pressure is 0%, the green lights are lit, when the brake pressure is about 1% to about 80% the yellow or amber lights are lit, and when the brake pressure is greater than about 80% the red lights are lit. In another embodiment, when the brake pressure is about 0% to about 10% the green lights are lit, when the brake pressure is about 10% to about 90% the yellow or amber lights are lit, and when the brake pressure is greater than about 90% the red lights are lit. These ranges are only given as examples and one of ordinary skill would appreciate that various possibilities are contemplated.

Embodiments of the invention are described in detail in the drawings. The drawings, however, are merely illustrative of how the invention might be put into effect such that the specific form and substance disclosed is not to be understood as limiting the invention and its application to a vehicles standard two brake light system in light of the various rear-end designs of vehicles.

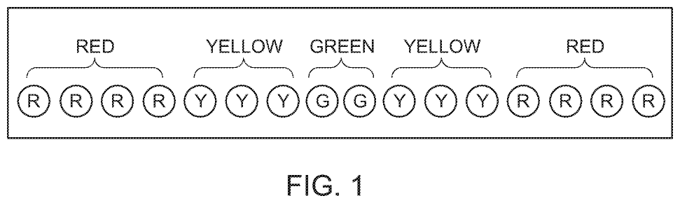

FIG. 1 shows one embodiment of the present disclosure.

In FIG. 1, the letter “G” represents the color green (go) in the center of the display system, which is the default color, and indicates that there is no pressure exerted on the brake pedal. When there is no pressure exerted on the brake pedal, this color will be the only color lighted, for example, as signaled by a microprocessor.

In FIG. 1, the letter “Y” represents the colors yellow (caution) on each side of the green (go) color. This will be the only color lighted when a driver is partially depressing the brake pedal, for example, as signaled by a microprocessor.

In FIG. 1, the letter “R” represents the color red (stop) on both ends of the yellow (caution) color. This will be the only color lighted when the brake pedal is fully or nearly fully depressed, for example, as signaled by the microprocessor.

Each color light(s) will be extinguished by another color when the force on the brake pedal is sufficiently changed.

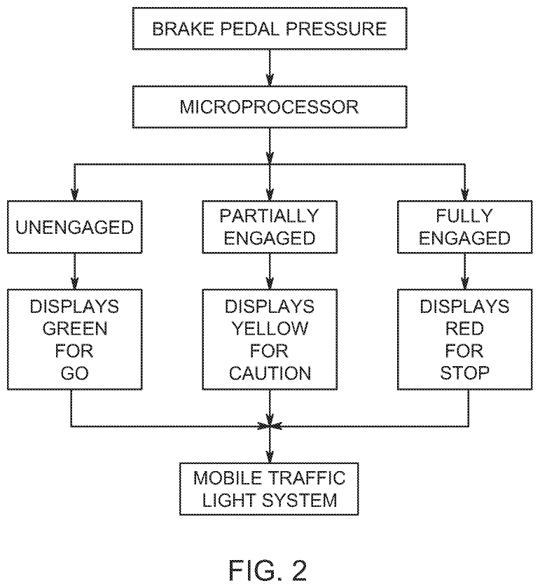

FIG. 2 shows another embodiment of the disclosure.

In FIG. 2, a microprocessor is the electronic command and control center which analyses the position and/or applied pressure on the brake pedal to appropriately display the correct color signal shown on the mobile traffic light system display.

In FIG. 2, the brake pedal position represents the various pressure positions of a brake pedal as described below.

Brake pedal unengaged: the brake pedal status when there is no pressure applied on it.

Brake pedal partially engaged: the brake pedal status once pressure is applied on the pedal prior to an actual stop.

Fully engaged: the brake pedal status when the vehicle is in a stop mode.

Displays green for go: when the microprocessor senses no pressure on the brake pedal it sends a signal to the mobile traffic light system to show green.

Displays yellow for caution: when the microprocessor senses pressure on the brake pedal prior to a stop, it sends a signal to the mobile traffic system to show yellow.

Displays red for stop: when the microprocessor senses the brake pedal to be in the stop mode, the microprocessor sends a signal to the mobile traffic system to show red to mean stop.

A mobile traffic light system: an electronic system to show the changing color representation transmitted by the microprocessor according to the pressure and or position of the brake pedal of the vehicle.

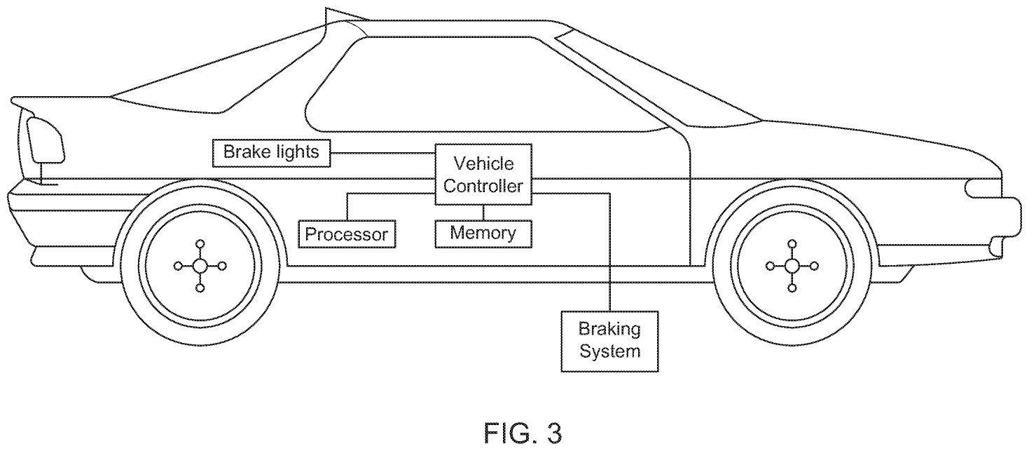

FIG. 3 shows a safety brake system of the disclosure. In FIG. 3 the brake system is connected to a vehicle controller and processor which controls the brake lights.

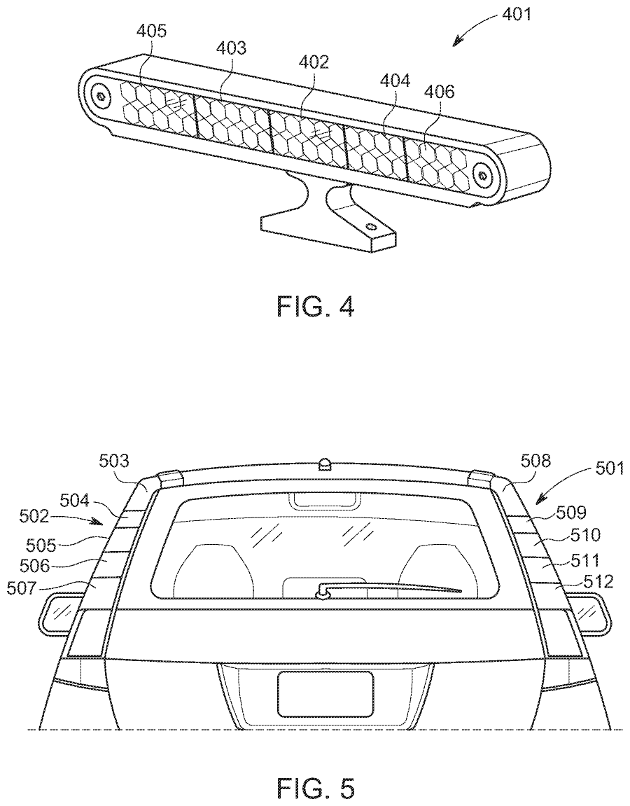

FIG. 4 shows an embodiment of brake lights 401 of the disclosure. In FIG. 4, 402 is a green light section including one or more green lights, 403 and 404 are yellow light sections including one or more yellow lights, and 405 and 406 are red light sections including one or more red lights. While a horizontal orientation is shown, the embodiment of FIG. 4 could be positioned in either a horizontal or vertical or other direction. As further described below, the other permutations of the light configurations are also possible. For example, the left most section could be red, middle section yellow, and rightmost section green. The opposite configuration is possible as well, right section red, middle section yellow, and left most section green.

FIG. 5 shows an embodiment of brake lights 501 and 502 of the disclosure. In FIGS. 5, 505 and 510 are green light sections, 504, 506, 509, and 511 are yellow light sections, and 503, 507, 508, and 512 are red light sections. These are examples and the respective areas could be of different colors as well. For example, 505 and 510 could be red, 504, 506, 509, and 511 could be yellow and 503, 507, 508, and 512 could be green. The other possible permutations are included as well in this and the other examples. For example, the top section could be red, middle section yellow, and bottom section green, or bottom red, middle yellow, and top green, or any other pattern/configuration.

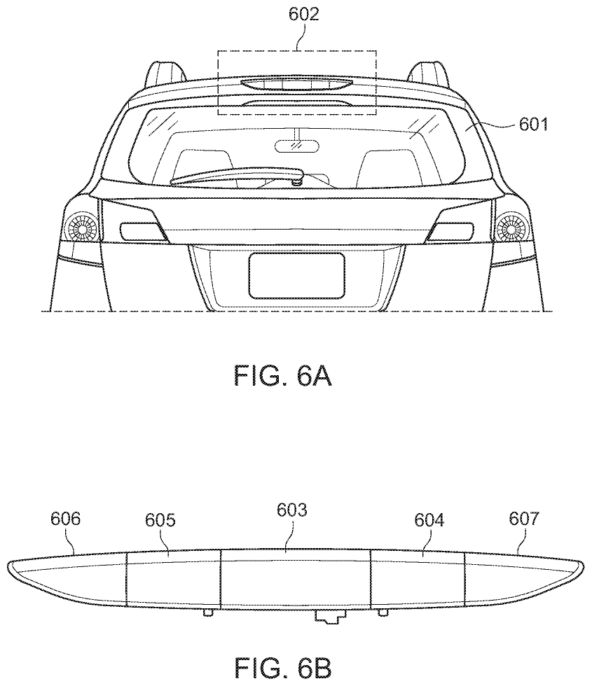

FIG. 6A shows car 601 with brake lights 602.

FIG. 6B shows an exploded view of brake lights 602 with green section 603, yellow light sections 604 and 605, and red-light sections 606 and 607. Again, the other color configuration patterns/permutations are also possible.

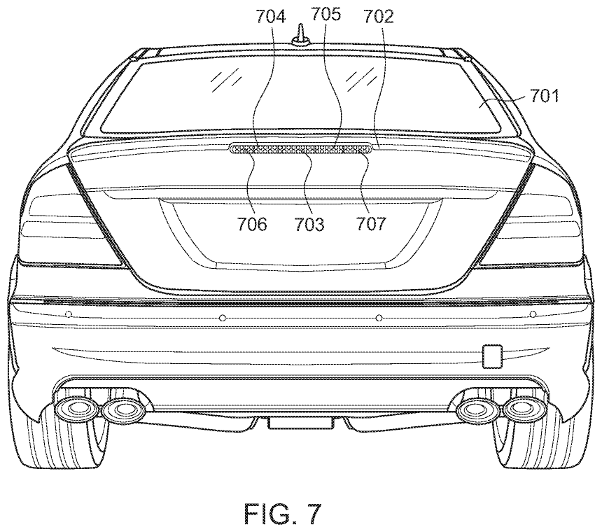

FIG. 7 shows car 701 with brake lights 702. Brake lights 702 include green light section 703, yellow light sections 704 and 705, and red-light sections 706 and 707.

While this disclosure includes specific examples, it will be apparent after an understanding of the disclosure of this application has been attained that various changes in form and details may be made in these examples without departing from the spirit and scope of the claims and their equivalents.

We claim:

1. A brake light system for a vehicle comprising:
a brake pedal comprising a pressure sensor configured to output a signal corresponding to an amount of pressure on the brake pedal;
a microprocessor configured to read the signal from the pressure sensor;
brake lights comprising one or more green lights, one or more yellow lights, and one or more red lights;
wherein when the brake pedal has about 0% pressure on it, only the one or more green light(s) are on;
when the brake pedal has about 1% to about 90% pressure on it, only the one or more yellow light(s) are on,
when the brake pedal has about 90% to about 100% pressure on it, only the one or more red light(s) are on;
wherein the pressure ranges from 0% to 100% such that 100% pressure completely stops the vehicle's wheels and 0% pressure represents no pressure being applied to the brake pedal.

2. The brake light system for a vehicle of claim 1, wherein the one or more green light(s) are positioned with one or more yellow lights adjacent to and on both sides of the green light(s), and the one or more red lights are positioned adjacent to and on both sides of the one or more yellow lights.

3. The brake light system for a vehicle of claim 2, wherein the one or more green lights, the one or more yellow lights, and the one or more red lights are positioned substantially in a horizontal plane.

4. The brake light system for a vehicle of claim 2, wherein the one or more green lights, the one or more yellow lights, and the one or more red lights are positioned substantially in a vertical plane.

5. The brake light system for a vehicle of claim 1, wherein the brakes are hydraulic brakes comprising a hydraulic fluid that transmits a pressure from the brake pedal to a vehicle wheel braking system.

6. The brake light system for a vehicle of claim 5, wherein the pressure sensor is a transducer that measures the pressure of the hydraulic brake fluid.

7. A method of warning a driver of a second motor vehicle driving behind a first motor vehicle comprising:
displaying one or more green lights on or near the backside of the first motor vehicle when the first motor vehicle is exerting about 0% pressure on the first motor vehicle brake pedal;
displaying one or more yellow lights on or near the backside of the first motor vehicle when the first motor vehicle is exerting about 1% to about 90% pressure on the first motor vehicle brake pedal;
displaying one or more red lights on or near the backside of the first motor vehicle when the first motor vehicle exerts about 90% to about 100% pressure on the first motor vehicle brake pedal,
wherein pressure ranges from 0% to 100% such that 100% pressure completely stops the vehicle's wheels and 0% represents no pressure being applied to the brake pedal.

8. The method of claim 7, wherein the one or more green light(s) are positioned with one or more yellow lights adjacent to and on both sides of the green light(s), and one or more red lights are positioned adjacent to and on both sides of the one or more yellow lights.

9. The method of claim 8, wherein the one or more green lights, one or more yellow lights, and one or more red lights are positioned substantially in a horizontal plane.

10. The method of claim 8, wherein the one or more green lights, one or more yellow lights, and one or more red lights are positioned substantially in a vertical plane.

11. The method of claim 7, wherein the brakes are hydraulic brakes comprising a hydraulic fluid that transmits a pressure from a brake pedal to a vehicle wheel braking system.
